(19) United States
(12) Patent Application Publication
(10) Pub. No.: US 2019/0214675 A1
(43) Pub. Date: Jul. 11, 2019

(54) Method of Forming a Secondary Battery

(71) Applicant: Robert Bosch GmbH, Stuttgart (DE)

(72) Inventors: John Christensen, Elk Grove, CA (US); Aleksandar Kojic, Sunnyvale, CA (US)

(21) Appl. No.: 16/312,571

(22) PCT Filed: Jun. 30, 2017
(86) PCT No.: PCT/EP2017/066256

§ 371 Date: Dec. 21, 2018

Related U.S. Application Data
(60) Provisional application No. 62/356,898, filed on Jun. 30, 2016.

(51) Int. Cl. H01M 10/058; H01M 4/04; H01M 10/052; H01M 10/44

(52) U.S. Cl. CPC H01M 10/058; H01M 10/446; H01M 10/052; H01M 4/0445

(57) ABSTRACT

A method of forming a battery cell including forming an anode region including a current collector, a porous intercalation material, and an anolyte. The method also includes forming an ionically conductive separator and forming a cathode region including a current collector and a porous intercalation material. The method also includes adding a first lithium reaction product and a first catholyte to the cathode region and applying a charging current between the cathode and anode. The method also includes removing a reduction by-product from the battery cell. An embodiment also includes a battery formed by the method.

### FIELD

The invention generally relates to a secondary battery, and more particularly to a method of forming a secondary battery.

### BACKGROUND

Rechargeable lithium batteries are attractive energy storage devices for portable electric and electronic devices and electric and hybrid-electric vehicles because of their high specific energy compared to other electrochemical energy storage devices. A typical lithium cell contains a negative electrode, a positive electrode, and a separator located between the negative and positive electrodes. Both electrodes contain active materials that react with lithium reversibly. In some cases, the negative electrode may include lithium metal, which can be electrochemically dissolved and deposited reversibly. The separator contains an electrolyte with a lithium cation, and serves as a physical barrier between the electrodes such that none of the electrodes are electrically connected within the cell.

Typically, during charging, there is generation of electrons at the positive electrode and consumption of an equal amount of electrons at the negative electrode. During discharging, opposite reactions occur.

Conventional methods of forming a battery cell find it challenging to controllably fabricate lithium films having a thickness less than about 30 microns. In order to accommodate a desired battery capacity it is often necessary to manufacture the cell with a high negative to positive electrode capacity (e.g., excess lithium). This manufacturing technique results in battery cells that are heavier and larger than necessary to provide the desired capacity. What is therefore needed is a method of making a battery cell that results in a lighter and smaller battery cell having the desired capacity.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure are related to systems and methods for forming a secondary battery.

In one embodiment, the present invention provides a method of forming a battery cell. The method includes forming an anode region comprising a current collector. The method also includes forming an ionically conductive separator and forming a cathode region including a current collector, conductive additive(s), a (mostly) continuous pore structure that can accommodate a liquid and/or gas, and an electrochemically active material (e.g., lithium-insertion material). The method also includes flowing a first liquid catholyte including a first lithium reaction product into the cathode region and applying a charging current to the cell. An embodiment also includes a battery cell formed by the method.

The present invention also provides a method of forming a battery cell including forming an anode region including a current collector, and an electrochemically active material (e.g., lithium insertion material). The method also includes forming an ionically conductive separator and forming a cathode region including a current collector and an electrochemically active material. The method also includes adding a first lithium reaction product and a first catholyte to the cathode region and applying a charging current between the cathode and anode. The method also includes removing a reduction by-product from the battery cell. An embodiment also includes a battery cell formed by the method.

The present invention also provides a battery cell. The amount of lithium metal in the battery cell may be about 100 percent to about 125 percent of the capacity of the cathode region to store a lithium reaction product.

The details of one or more features, aspects, implementations, and advantages of this disclosure are set forth in the accompanying drawings, the detailed description, and the claims below.

### BRIEF DESCRIPTION OF THE DRAWINGS

FIG. 1 is a schematic diagram illustrating a battery including a battery cell, in accordance with some embodiments.

FIG. 2 is a flowchart describing an embodiment of a method for forming a battery cell, in accordance some embodiments.

FIG. 3 is a flowchart describing an embodiment of a method for forming a battery cell, in accordance some embodiments.

### DETAILED DESCRIPTION

One or more specific embodiments will be described below. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

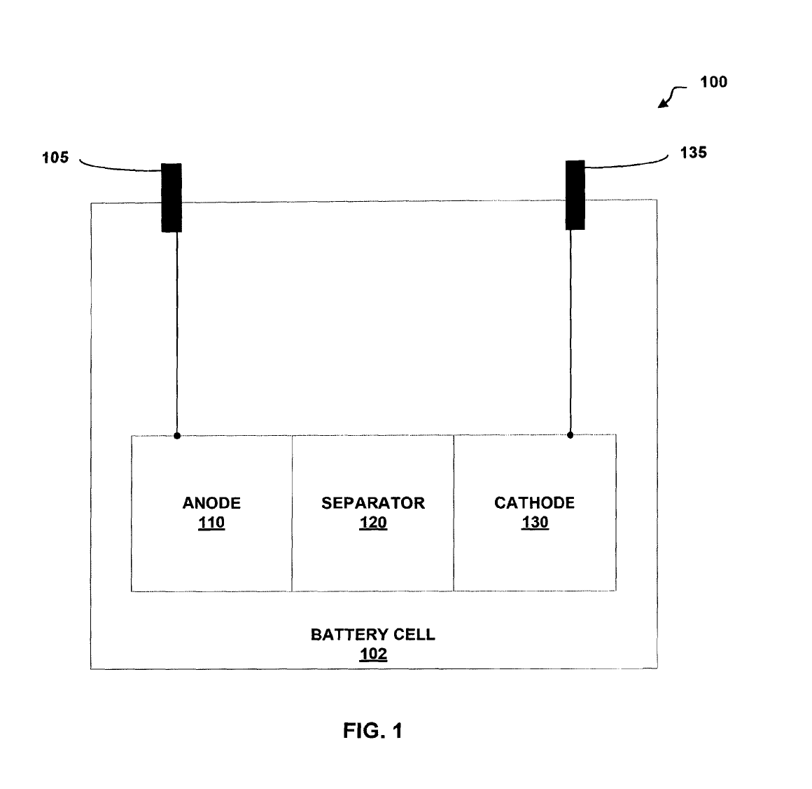

An embodiment of a battery 100 is shown in FIG. 1. The battery 100 includes a battery cell 102, an anode current collector 105, an anode region 110, a separator 120, a cathode region 130, and a cathode current collector 135. In various examples, the anode current collector 105 comprises a metal foil (e.g., copper, nickel, titanium) and/or a lithium insertion material (e.g., graphite). In various examples, the anode 110 may include an oxidizable metal (e.g., lithium), a material capable of intercalating lithium (e.g., graphite or silicon), a solid polymer electrolyte or polymer binder (e.g., polyethylene oxide, polyacrylonitrile, polyvinylidene fluoride, or polyvinylidene fluoride-hexa fluoropropylene), an electronicallyconductive additive (e.g., carbon black, graphite, or graphene), ionically conductive ceramics (e.g., lithium phosphorous oxynitride (LiPON), lithium aluminum titanium phosphate (LATP), or lithium aluminum germanium phosphate (LAGP)). In various examples, suitable materials for the separator 120 may include porous polymers (e.g., polyolefins), polymer electrolytes (e.g., polystyrene-polyethylene oxide (PS-PEO)), ceramics (e.g., lithium phosphorous oxynitride (LiPON), lithium aluminum titanium phosphate (LATP), or lithium aluminum germanium phosphate (LAGP)), and/or two dimensional sheet structures (e.g., graphene, boron nitride, or dichalcogenides). In various examples, the cathode region may include an active cathode material such as, but not limited to, sulfur or sulfur-containing materials (e.g., polyacrylonitrile-sulfur composites (PAN-S composites) or lithium sulfide (Li₂S)); vanadium oxides (e.g., vanadium pentoxide (V₂O₅)); metal fluorides (e.g., fluorides of titanium, vanadium, iron, cobalt, bismuth, copper and combinations thereof); lithium-insertion materials (e.g., lithium nickel manganese cobalt oxide (NMC), lithium-rich NMC, or lithium nickel manganese oxide (LiNi_{0.5}Mn_{1.5}O₄)); lithium transition metal oxides (e.g., lithium cobalt oxide (LiCoO₂), lithium manganese oxide (LiMn₂O₄), lithium nickel cobalt aluminum oxide (NCA), and combinations thereof); lithium phosphates (e.g., lithium iron phosphate (LiFePO₄)), a porous conductive material (e.g., carbon black, carbon fiber, graphite, graphene and combinations thereof) and an electrolyte. In various examples, the cathode current collector 135 may include a metal foil (e.g., aluminum or titanium).

In some embodiments, the cathode region 130, separator 120, and/or anode 110 may include an ionically conductive electrolyte that further contains a metal salt (e.g., lithium hexafluorophosphate (LiPF₆), lithium bis-trifluoromethanesulfonimide (LiTFSI), or lithium perchlorate (LiClO₄) dissolved in a blend of cyclic and/or linear carbonates, ethers, ionic liquids, and/or other solvents) that provides the electrolyte with additional conductivity which reduces the internal electrical resistance of the battery cell.

In various embodiments the thickness dimension of the components of the battery cell 102 may be for the anode region 110 about 5 to about 120 micrometers, for the separator 120 less than about 50 micrometers or in certain embodiments less than about 10 micrometers, and for the cathode region 130 about 50 to about 120 micrometers. The ranges of anode and cathode thicknesses do not include the thicknesses of the current collectors and they only account for the one side of each electrode in the case of double-sided electrodes.

During the discharge of battery cell 102, lithium is oxidized at the anode region 110 to form a lithium ion. The lithium ion migrates through the separator 120 of the battery cell 102 to the cathode region 130. During charging the lithium ions return to the anode region 120 and are reduced to lithium. The lithium may be deposited as lithium metal on the anode region 110 in the case of a lithium anode region 110 or inserted into the host structure in the case of an insertion material anode region 110, such as graphite, and the process is repeated with subsequent charge and discharge cycles. In the case of a graphitic or other Li-insertion electrode, the lithium cations are combined with electrons and the host material (e.g., graphite), resulting in an increase in the degree of lithiation, or “state of charge” of the host material. For example, x Li⁺+x e⁻+C₆→LiₓC₆. In some embodiments, the amount of lithium metal in the battery cell is about 100 percent to about 125 percent of the capacity of the cathode region to store a lithium reaction product.

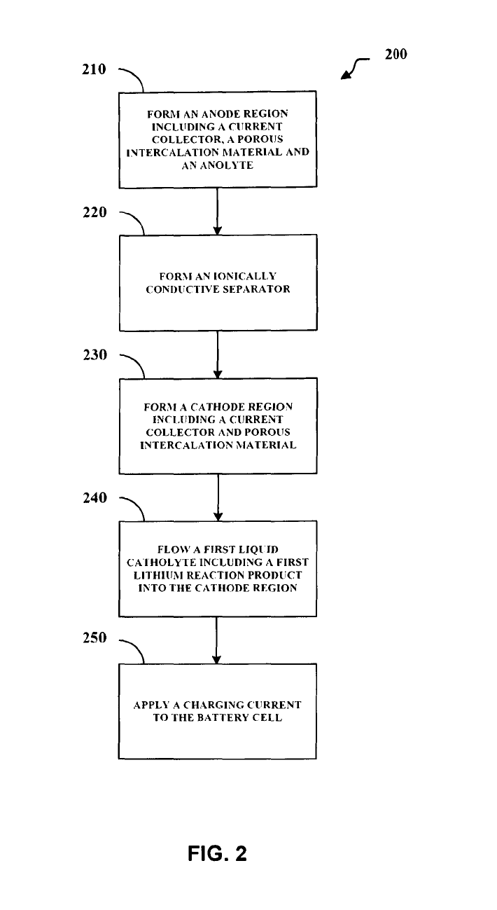

FIG. 2 is a flowchart of a method 200 of making a battery cell. In some embodiments, the method 200 may be used to make the battery cell 102. In the example of FIG. 2, at block 210, an anode region 110 is formed comprising an anode current collector 105 (e.g., a metal foil) and an anode region electrolyte (e.g., anolyte). In some embodiments, the anode region 110 may further include a porous material capable of intercalating lithium. In some embodiments, the anode region 110 may be initially formed free of the oxidizable metal (e.g., lithium).

In the example of FIG. 2, at block 220, a separator 120 is formed on the anode region 110. The separator 120 electrically isolates the anode region 110 while allowing lithium ions to pass into and out of the anode region 110.

In the example of FIG. 2, at block 230, a cathode region 130 is formed on the separator 120. The cathode region 130 may include a cathode current collector 135 and a cathode region electrolyte (e.g., catholyte). In some embodiments, the cathode region 130 may further include a cathode active material, an electronically conductive material (e.g., carbon fiber, graphite, and/or carbon black) or porous substrate (e.g., Ni foam, porous C, SiC fibers, etc.), a gas diffusion layer, a gas flowfield, and any additional components. In an alternative embodiment, the anode region 110, separator 120, and cathode region 130 may be laminated together in a single step.

In the example of FIG. 2, at block 240, a first liquid electrolyte (e.g., first catholyte) is added to the cathode region 130. In some embodiments, the first catholyte may include an organic electrolyte (e.g., cyclic carbonates, linear carbonates, ethers, dimethyl ether (DME), dimethyl sulfoxide (DMSO), furans, nitriles and combinations thereof), a lithium salt (e.g., lithium hexafluorophosphate (LiPF₆), lithium perchlorate (LiClO₄), lithium carbonate (Li₂CO₃) and combinations thereof), and/or a lithium reaction product (e.g., lithium peroxide (Li₂O₂), lithium oxide (Li₂O), lithium carbonate (Li₂CO₃) and combinations thereof). In certain embodiments, the first catholyte may additionally include a charging redox couple (e.g., metallocenes (e.g., ferrocene, n-butyl ferrocene, N,N-Dimethylferrocene), halogens (e.g., I-/I3-), aromatic molecules (e.g., tetramethylphenylenediamine)). In some embodiments, the first catholyte may include a molten electrolyte (e.g., nitrate or nitrate-nitrate eutectic), a lithium salt (e.g., lithium chloride (LiCl)), and/or a lithium reaction product (e.g., lithium peroxide (Li₂O₂), lithium oxide (Li₂O), lithium carbonate (Li₂CO₃) and combinations thereof). In certain embodiments, the first catholyte may additionally include a charging redox couple (e.g., metallocenes (e.g., ferrocene, n-butyl ferrocene, N,N-Dimethylferrocene), halogens (e.g., I-/I3-), aromatic molecules (e.g., tetramethylphenylenediamine)). In some embodiments, the first catholyte may include an aqueous electrolyte, a lithium salt (e.g., LiOH, LiCl and combinations thereof) and a lithium reaction product (e.g., lithium peroxide (Li₂O₂), lithium oxide (Li₂O), lithium carbonate (Li₂CO₃) and combinations thereof). In certain embodiments, the first catholyte may additionally include a charging redox couple (e.g., metallocenes (e.g., ferrocene, n-butyl ferrocene, N,N-Dimethylferrocene), halogens (e.g., I-/I3-), aromatic molecules (e.g., tetramethylphenylenediamine)).

In the example of FIG. 2, at block 250, a charging current is applied to the battery cell 102 causing the lithium ions dissolved in the cathode region electrolyte (e.g., catholyte) to migrate through the separator 120 to the anode region 110 where they are reduced to lithium. The charging current and duration of the application of the charging current, as well as the quantity of lithium containing first catholyte supplied to the cathode region 130, control the thickness of the deposited lithium in the anode region 110. In cases where the lithium reaction product (i.e., lithium source) is insoluble or sparingly insoluble, a redox additive with redox voltage above that of the redox potential of the lithium reaction product may be added in order to facilitate oxidation of the lithium reaction product. In some embodiments, the thickness of the deposited lithium is at least about 5 microns, and/or less than about 100 microns. In some embodiments, the amount of lithium metal in the battery cell has a capacity that is about 100 percent to about 125 percent of the capacity of the cathode region to store a lithium reaction product.

In some embodiments, the first catholyte is continuously provided to the cathode region 130 during application of the charging current. In some embodiments, the first catholyte includes a first lithium salt (e.g., lithium bis-trifluoromethanesulfonimide (LiTFSI), lithium hexafluorophosphate (LiPF₆), lithium perchlorate (LiClO₄)). In some embodiments, the first catholyte is removed after application of the charging current (e.g., vacuum dried) and replaced with a second catholyte. In some embodiments, the second catholyte may include an organic electrolyte (e.g., cyclic carbonates, linear carbonates, ethers, dimethyl ether (DME), dimethyl sulfoxide (DMSO), furans, nitriles and combinations thereof), a lithium salt (e.g., lithium hexafluorophosphate (LiPF₆), lithium perchlorate (LiClO₄), lithium carbonate (Li₂CO₃) and combinations thereof), and/or a lithium reaction product (e.g., lithium peroxide (Li₂O₂), lithium oxide (Li₂O), lithium carbonate (Li₂CO₃) and combinations thereof). In certain embodiments, the second catholyte may additionally include a charging redox couple (e.g., metallocenes (e.g., ferrocene, n-butyl ferrocene, N,N-Dimethylferrocene), halogens (e.g., I-/I3-), aromatic molecules (e.g., tetramethylphenylenediamine)). In some embodiments, the second catholyte may include a molten electrolyte (e.g., nitrate or nitrate-nitrate eutectic), a lithium salt (e.g., lithium chloride (LiCl)), and/or a lithium reaction product (e.g., lithium peroxide (Li₂O₂), lithium oxide (Li₂O), lithium carbonate (Li₂CO₃) and combinations thereof). In certain embodiments, the second catholyte may additionally include a charging redox couple (e.g., metallocenes (e.g., ferrocene, n-butyl ferrocene, N,N-Dimethylferrocene), halogens (e.g., I-/I3-), aromatic molecules (e.g., tetramethylphenylenediamine)). In some embodiments, the second catholyte may include an aqueous electrolyte, a lithium salt (e.g., LiOH, LiCl and combinations thereof) and a lithium reaction product (e.g., lithium peroxide (Li₂O₂), lithium oxide (Li₂O), lithium carbonate (Li₂CO₃) and combinations thereof). In certain embodiments, the second catholyte may additionally include a charging redox couple (e.g., metallocenes (e.g., ferrocene, n-butyl ferrocene, N,N-Dimethylferrocene), halogens (e.g., I-/I3-), aromatic molecules (e.g., tetramethylphenylenediamine)). In some embodiments, the first catholyte is different from the second catholyte. In other embodiments, the first catholyte may be the same as the second catholyte. In some embodiments, the second catholyte includes a second lithium salt (e.g., lithium bis-trifluoromethanesulfonimide (LiTFSI), lithium hexafluorophosphate (LiPF₆), lithium perchlorate (LiClO₄)). In certain embodiments, the first lithium salt is different from the second lithium salt.

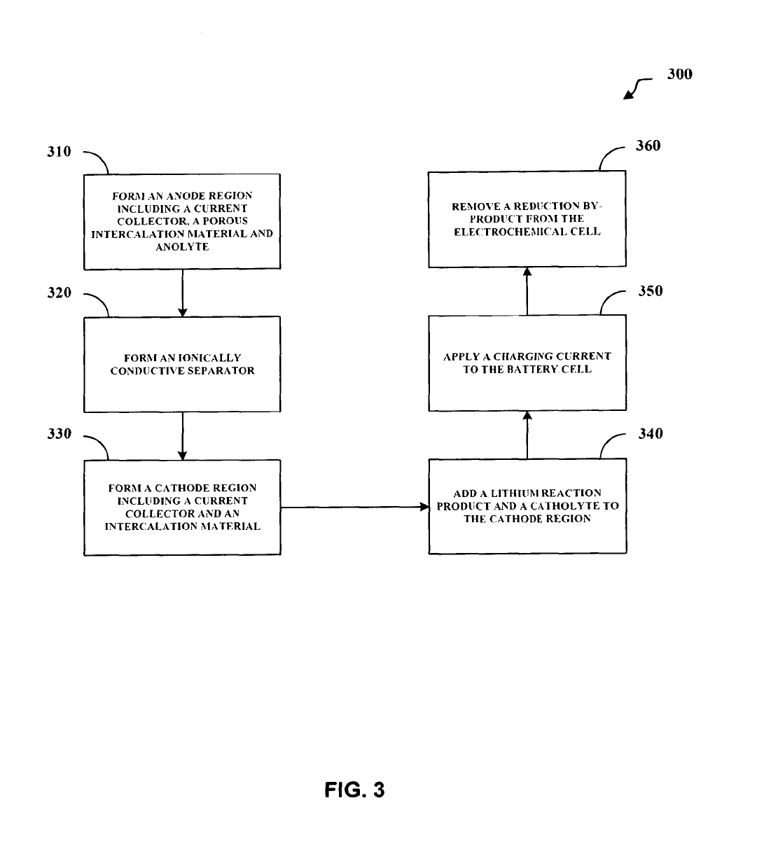

FIG. 3 is a flowchart of a method 300 of making a battery cell. In some embodiments, the method 300 may be used to make the battery cell 102. In the example of FIG. 3, at block 310 an anode region 110 is formed comprising an anode current collector 105 (e.g., a metal foil) and an anode region electrolyte (e.g., anolyte). In some embodiments, the anode region 110 may further include a material capable of intercalating lithium. At block 320, a separator 120 is laminated with the anode region 110. The separator 120 electrically isolates the anode region 110 while allowing lithium ions to pass into and out of the anode region 110. At block 330, a cathode region 130 is laminated with the separator 120. The cathode region 130 may include a cathode current collector 135. In some embodiments, the cathode region 130 may further include a cathode active material, an intercalation material, a gas diffusion layer, a gas flowfield, and any additional components. At block 340, a lithium reaction product (e.g., lithium peroxide (Li₂O₂), lithium oxide (Li₂O), lithium chloride (LiCl), lithium bromide (LiBr), lithium carbonate (Li₂CO₃), lithium hydroxide (LiOH or LiOH.H₂O)), an electrochemically active (e.g., lithium-insertion) material, and a cathode region electrolyte (e.g., catholyte) are added to the cathode region 130. In some embodiments, the lithium reaction product is in solid form. In some embodiments, the catholyte is in solid form. In certain embodiments, both the lithium reaction product and the catholyte are in solid form. At block 350, a charging current is applied to the battery cell 102 causing the lithium reaction product to dissociate allowing the lithium ions to migrate through the separator 120 to the anode region 110 where they are reduced to lithium. The charging current and duration of the application of the charging current, as well as the quantity of lithium containing first catholyte supplied to the cathode region 130, control the thickness of the deposited lithium in the anode region 110. In some embodiments, the thickness of the deposited lithium is at least about 5 microns, and/or less than about 100 microns. At block 360, the by-product formed by the reduction of the lithium of the lithium reaction product (e.g., oxygen (O₂), chlorine (Cl₂), bromine (Bra)) may be removed from the battery cell 102 during and/or after application of the charging current. In certain embodiments, the by-product may be removed via a vent and/or a valve. In certain embodiments, the by-product may be removed by opening a sealed battery cell 102, removing the by-product, and re-sealing the battery cell 102.

In some embodiments, the method of FIG. 2 may be used in combination with the method of FIG. 3. In certain embodiments the methods of FIG. 2 and FIG. 3 may be used sequentially.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the spirit and scope of this disclosure.

What is claimed is:

1. A method of forming a battery cell comprising:
a) forming an anode region comprising a current collector;
b) forming an ionically conductive separator;
c) forming a cathode region comprising a current collector and electrochemically active material;
d) flowing a first liquid electrolyte comprising a first lithium reaction product into the cathode region;
e) applying a charging current to the cell.

2. The method of claim 1, wherein the anode region further comprises an anolyte.

3. The method of claim 1, wherein the first liquid electrolyte is continuously flowing into the cathode region while the charging current is applied.

4. The method of claim 1, wherein the first lithium reaction product comprises lithium chloride (LiCl), lithium bromide (LiBr), lithium hydroxide (LiOH), or lithium hydroxide monohydrate (LiOH.H₂O)lithium peroxide (Li₂O₂) or lithium oxide (Li₂O).

5. The method of claim 1, wherein a concentration of the first lithium reaction product remains substantially constant during application of the charging current.

6. The method of claim 1, wherein the first liquid electrolyte comprises a material selected from the list consisting of an organic electrolyte, a molten electrolyte, and an aqueous electrolyte.

7. The method of claim 6, wherein the first liquid electrolyte comprises the organic electrolyte further comprising an organic solvent, a lithium salt and a lithium reaction product.

8. The method of claim 6, wherein the first liquid electrolyte comprises the molten electrolyte further comprising a nitrate or a nitrate-nitrate eutectic, a lithium salt and a lithium reaction product.

9. The method of claim 6, wherein the first liquid electrolyte comprises the aqueous electrolyte further comprising water or an alcohol, a lithium salt and a lithium reaction product.

10. The method of claim 6, wherein the first liquid electrolyte further comprises a charging redox couple.

11. The method of claim 1, further comprising removing the first liquid electrolyte.

12. The method of claim 11, wherein the first liquid electrolyte is removed by vacuum drying.

13. The method of claim 11, further comprising adding a second electrolyte to the cathode region.

14. The method of claim 13, wherein the second electrolyte is added after the removal of the first liquid electrolyte.

15. The method of claim 13, wherein the second electrolyte comprises a material selected from the list consisting of an organic electrolyte, a molten electrolyte, and an aqueous electrolyte.

16. The method of claim 15, wherein the second electrolyte comprises the organic electrolyte further comprising an organic solvent, a lithium salt and a lithium reaction product.

17. The method of claim 15, wherein the second electrolyte comprises the molten electrolyte further comprising a nitrate or a nitrate-nitrate eutectic, a lithium salt and a lithium reaction product.

18. The method of claim 15, wherein the second electrolyte comprises the aqueous electrolyte further comprising water or an alcohol, a lithium salt and a lithium reaction product.

19. The method of claim 15, wherein the second electrolyte further comprises a charging redox couple.

20. The method of claim 1, wherein the anode region further comprises a lithium intercalation material.

21. The method of claim 1, wherein the anode region is initially formed free of an oxidizable metal.

22. A method of forming a battery cell comprising:
a) forming an anode region comprising a current collector, a lithium intercalation material and an anolyte;
b) forming an ionically conductive separator;
c) forming a cathode region comprising a current collector and a electrochemically active material;
d) adding a first lithium reaction product and a first electrolyte to the cathode region;
e) applying a charging current between the cathode and the anode;
f) removing a reduction by-product from the battery cell.

23. The method of claim 22, wherein the first lithium reaction product comprises lithium peroxide (Li₂O₂), lithium oxide (Li₂O), lithium bromide (LiBr), or lithium chloride (LiCl).

24. The method of claim 22, further comprising adding a second electrolyte to the cathode region.

25. The method of claim 24, wherein the second electrolyte comprises a solid electrolyte.

26. The method of claim 24, wherein the second electrolyte comprises a polymer electrolyte.

27. The method of claim 22, further comprising sealing the battery cell after the addition of the first lithium reaction product and the first electrolyte to the cathode region.

28. The method of claim 27, further comprising unsealing the battery cell prior to the removal of the reduction by-product.

29. The method of claim 28, wherein unsealing the battery cell comprises opening a valve.

30. The method of claim 22, wherein the anode region is initially formed free of an oxidizable metal.

31. A battery cell formed by the method of claim 1,
wherein the amount of lithium metal in the battery cell is about 100 percent to about 125 percent of the capacity of the cathode region to store a lithium reaction product.

32. The battery cell of claim 31, wherein a thickness of the lithium metal of the anode region is about 5 microns to about 100 microns.

33. A battery cell formed by the method of claim 22,
wherein the amount of lithium metal in the battery cell is about 100 percent to about 125 percent of the capacity of the cathode region to store a lithium reaction product.

34. The battery cell of claim 33, wherein a thickness of the lithium metal of the anode region is about 5 microns to about 100 microns.
